(19) United States
(12) Patent Application Publication
(10) Pub. No.: US 2010/0060833 A1
(43) Pub. Date: Mar. 11, 2010

(54) LIQUID CRYSTAL DISPLAY PROTECTION PLATE

(75) Inventors: Shinsuke Ochiai, Niihama-shi (JP); Koji Koyama, Niihama-shi (JP); Masakazu Sumida, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIITED, Tokyo (JP)

(21) Appl. No.: 12/552,587

(22) Filed: Sep. 2, 2009

(30) Foreign Application Priority Data
Sep. 3, 2008 (JP) 2008-225709
Jul. 16, 2009 (JP) 2009-167676

(51) Int. Cl. G02F 1/1335; G02F 1/1333

(52) U.S. Cl. 349/117; 349/122

(57) ABSTRACT

The invention provides a liquid crystal display protection plate capable of suppressing deterioration of the visibility of an image in the case where a screen of a liquid crystal display is seen through a polarizing filter such as polarizing sunglasses. The liquid crystal display protection plate having an in-plane retardation value of 85 to 300 nm is constituted by a scratching-resistant resin plate in which a cured coating film is disposed on at least one face of a resin substrate. A laminate plate in which a methacrylic resin layer is laminated on at least one face of a polycarbonate resin layer is preferably used as the resin substrate.

### BACKGROUND OF THE INVENTION

1. Field of the Invention

The invention relates to a liquid crystal display protection plate comprising a scratching-resistant resin plate in which a cured coating film is disposed on at least one face of a resin substrate.

2. Description of the Related Art

It is investigated to use a scratching-resistant resin plate in which a scratching-resistant cured coating film is disposed on at least one face of a resin substrate as a liquid crystal display protection plate. For example, JP-A No. 2004-143365, JP-A No. 2004-299199, JP-A No. 2007-190794, JP-A No. 2006-6811, JP-A No. 2008-36927 and JP-A No. 2008-49697 disclose that a plate obtained by using a methacrylic resin plate as a substrate and forming a cured coating film on at least one face of the resin plate is used as a display window protection plate of a liquid crystal-type portable information terminal. Further, JP-A No. 2006-103169 and JP-A No. 2007-237700 disclose a laminate plate in which an acrylic resin layer is laminated on one face of a polycarbonate resin layer is used as a substrate and a cured coating film is disposed on the acrylic resin layer, the obtained plate being used for a liquid crystal display cover.

### SUMMARY OF THE INVENTION

A liquid crystal display protection plate is installed in the front face side (the viewer side) of a liquid crystal display and a screen of the liquid crystal display is seen through the protection plate and when a viewer sees a screen while putting on polarizing sunglasses, since a conventional liquid crystal display protection plate scarcely changes the polarization property of outgoing light, which is polarized light, from the liquid crystal display, the screen is sometimes so pitch dark that an image can be invisible or the screen is sometimes so dark that an image can be difficult to be seen depending on the angle between the polarization axis of the outgoing light and the transmission axis of the polarizing sunglasses. Therefore, an object of the invention is to provide a liquid crystal display protection plate capable of suppressing deterioration of the visibility of an image in the case where a screen of a liquid crystal display is seen through a polarizing filter such as polarizing sunglasses.

The inventors of the invention have made keen investigations and have found that a liquid crystal display protection plate comprising a scratching-resistant resin plate in which a cured coating film is disposed on at least one face of a resin substrate and having an in-plane retardation value within a prescribed range can satisfy the above-mentioned object and the finding has now led to completion of the invention.

That is, the invention provides a liquid crystal display protection plate, comprising a scratching-resistant resin plate in which a cured coating film is disposed on at least one face of a resin substrate and having an in-plane retardation value of 85 to 300 nm.

According to the liquid crystal display protection plate of the invention, in the case where a screen of a liquid crystal display is seen through a polarizing filter such as polarizing sunglasses, deterioration of the visibility of an image can be suppressed and the liquid crystal display can efficiently be protected.

### DETAILED DESCRIPTION OF THE PREFERRED EMBODIMENTS

Hereinafter, the invention will be described in detail. The liquid crystal display protection plate of the invention comprises a scratching-resistant resin plate in which a cured coating film is disposed on at least one face of a resin substrate.

A resin constituting the resin substrate is preferably a transparent thermoplastic resin and examples of the resin include methacrylic resins, polyester resins, polycarbonate resins, polycyclic olefin resins, polystyrene resins, methacryl-styrene copolymers (MS resins), acrylonitrile-styrene copolymers (AS resins), and poly(vinylidene fluoride) resins (PVDF resins). Among them, methacrylic resins are preferable since the resins have high surface hardness and are easy to form a cured coating film with high scratching resistance and also polycarbonate resins and styrene resins such as polystyrene resins and acrylonitrile-styrene copolymers, and polyester resins such as polyethylene terephthalate resins are preferable since the resins are easy to control an in-plane retardation value within a prescribed range.

The methacrylic resins are polymers containing methacrylic acid esters as a main component and may be homopolymers of methacrylic acid esters and copolymers of 50% by weight or more of a methacrylic acid ester and 50% by weight or more of another monomer other than the methacrylic acid ester, The methacrylic acid ester to be used may be, in general, an alkyl ester of methacrylic acid.

A preferable monomer composition of the methacrylic resins is, on the basis of the total 100% by weight of entire monomers, 50 to 100% by weight of an alkyl methacrylate, 0 to 50% by weight of an alkyl acrylate, and 0 to 49% by weight of monomers other than the former monomers and a more preferable monomer composition is 50 to 99.9% by weight of an alkyl methacrylate, 0.1 to 50% by weight of an alkyl acrylate, and 0 to 49% by weight of monomers other than the former monomers.

Herein, examples of the alkyl methacrylate include methyl methacrylate, ethyl methacrylate, butyl methacrylate, and 2-ethylhexyl methacrylate and the number of carbon atoms of the alkyl group is generally 1 to 8 and preferably 1 to 4. Among them, methyl methacrylate is preferably used.

Further, examples of the alkyl acrylate include methyl acrylate, ethyl acrylate, butyl acrylate, and 2-ethylhexyl acrylate and the number of carbon atoms of the alkyl group is generally 1 to 8 and preferably 1 to 4.

Further, the monomers other than the alkyl methacrylate and alkyl acrylate may be monofunctional monomers, that is, compounds having one polymerizable carbon-carbon double bond in a molecule and also multifunctional monomers, that is, compounds at least two polymerizable carbon-carbon double bonds in a molecule, and monofunctional monomers are used preferably. Examples of the monofunctional monomers include aromatic alkenyl compounds such as styrene, α-methylstyrene, and vinyltoluene; alkenylcyano compounds such as acrylonitrile and methacrylonitrile; unsaturated carboxylic acids such as acrylic acid and methacrylic acid; maleic anhydride and N-substituted maleimide.

Furthermore, polymers having a glutaric anhydride structure [formula (1)] and glutarimide structure [formula (2)] which are obtained by cyclization reaction of copolymers of methyl methacrylate with acrylic acid or methacrylic acid may also be used as the methacrylic resins.

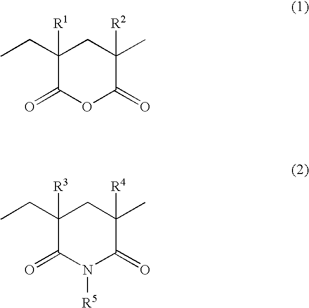

In the formula (1), R¹ represents a hydrogen atom or a methyl group and R² represents a hydrogen atom or a methyl group. In the formula (2), R³ represents a hydrogen atom or a methyl group; R⁴ represents a hydrogen atom or a methyl group; and R⁵ represents a hydrogen atom or a substituent group and examples of the substituent group is an alkyl group such as a methyl group and an ethyl group; a cycloalkyl group such as a cyclohexyl group; an aryl group such as a phenyl group; and an aralkyl group such as a benzyl group and the number of carbon atoms is generally 1 to 20.

Further, examples of the polyfunctional monomers include unsaturated polycarboxylic acid esters of polyhydric alcohols such as ethylene glycol dimethacrylate, butanediol dimethacrylate, and trimethylolpropane triacrylate; unsaturated carboxylic acid alkenyl esters such as allyl acrylate, allyl methacrylate, and allyl cinnamate; polyalkenyl esters of polybasic acids such as diallyl phthalate, diallyl maleate, triallyl cyanurate, and triallyl isocyanurate; and aromatic polyalkenyl compounds such as divinylbenzene.

In addition, two or more monomers of the above-mentioned alkyl methacrylate, alkyl acrylate, and monomers other than the former monomers may be used based on the necessity.

In terms of heat resistance, the methacrylic resins have a glass transition temperature of preferably 60° C. or higher and more preferably 80° C. or higher. The glass transition temperature can be properly set by adjusting the kinds of monomers and their ratio.

The methacrylic resins may be prepared by polymerizing the monomer components by a method such as suspension polymerization, emulsion polymerization, bulk polymerization, or the like. At this time, in order to obtain a preferable glass transition temperature, or to obtain viscosity showing proper formability on a resin substrate, it is preferable to use a chain transfer agent. The amount of the chain transfer agent may be determined properly in accordance with the kinds of monomers and their ratio.

Examples of the polycarbonate resins may be resins obtained by reaction of a dihydric phenol with a carbonylation agent by an interface polycondensation method, a melt ester exchange method, or the like; resins obtained by polymerization of a carbonate prepolymer by a solid-phase ester exchange method; and resins obtained by polymerization of a cyclic carbonate compound by a ring-opening polymerization method.

Examples of the dihydric phenol include hydroquinone, resorcinol, 4,4′-dihydroxydiphenyl, bis(4-hydroxyphenyl)methane, bis{(4-hydroxy-3,5-dimethyl)phenyl}methane, 1,1-bis(4-hydroxyphenyl)ethane, 1,1-bis(4-hydroxyphenyl)-1-phenylethane, 2,2-bis(4-hydroxyphenyl)propane (commonly known as bisphenol A), 2,2-bis{(4-hydroxy-3-methyl)phenyl}propane, 2,2-bis{(4-hydroxy-3,5-dimethyl)phenyl}propane, 2,2-bis{(4-hydroxy-3,5-dibromo)phenyl}propane, 2,2-bis{(3-isopropyl-4-hydroxy)phenyl}propane, 2,2-bis{(4-hydroxy-3-phenyl)phenyl}propane, 2,2-bis(4-hydroxyphenyl)butane, 2,2-bis(4-hydroxyphenyl)-3-methylbutane, 2,2-bis(4-hydroxyphenyl)-3,3-dimethylbutane, 2,4-bis(4-hydroxyphenyl)-2-methylbutane, 2,2-bis(4-hydroxyphenyl)pentane, 2,2-bis(4-hydroxyphenyl)-4-methylpentane, 1,1-bis(4-hydroxyphenyl)cyclohexane, 1,1-bis(4-hydroxyphenyl)-4-isopropylcyclohexane, 1,1-bis(4-hydroxyphenyl)-3,3,5-trimethylcyclohexane, 9,9-bis(4-hydroxyphenyl)fluorene, 9,9-bis{(4-hydroxy-3-methyl)phenyl}fluorene, α,α′-bis(4-hydroxyphenyl)-o-diisopropylbenzene, α,α′-bis(4-hydroxyphenyl)-m-diisopropylbenzene, α,α′-bis(4-hydroxyphenyl)-p-diisopropylbenzene, 1,3-bis(4-hydroxyphenyl)-5,7-dimethyladamantane, 4,4′-dihydroxydiphenylsulfone, 4,4′-dihydroxydiphenyl sulfoxide, 4,4′-dihydroxydiphenyl sulfide, 4,4′-dihydroxydiphenyl ketone, 4,4′-dihydroxydiphenyl ether, and 4,4′-dihydroxydiphenyl ester, and based on the necessity two or more kinds of these compounds may be used.

Among them, it is preferable to use a dihydric phenol alone or two or more dihydric phenols selected from the group consisting of bisphenol A, 2,2-bis{(4-hydroxy-3-methyl)phenyl}propane, 2,2-bis(4-hydroxyphenyl)butane, 2,2-bis(4-hydroxyphenyl)-3-methylbutane, 2,2-bis(4-hydroxyphenyl)-3,3-dimethylbutane, 2,2-bis(4-hydroxyphenyl)-4-methylpentane, 1,1-bis(4-hydroxyphenyl)-3,3,5-trimethylcyclohexane, and α,α′-bis(4-hydroxyphenyl)-m-diisopropylbenzene and particularly, it is preferable to use bisphenol A alone or bisphenol A in combination with 1,1-bis(4-hydroxyphenyl)-3,3,5-trimethylcyclohexane, or bisphenol A in combination with at least one kind of a dihydric phenol selected from the group consisting of, 2,2,-bis((4-hydroxy-3-methyl)phenyl)propane, and α,α′-bis(4-hydroxyphenyl)-m-diisopropylbenzene.

Examples of the carboxylation agent include carbonyl halides such as phosgene, carbonate esters such as diphenyl carbonate, and haloformates such as dihaloformates of dihydric phenols and based on the necessity, two or more kinds of them may be used.

A resin constituting a resin substrate may be used in form of a resin composition while being blended with other components. The components to be blended include, for example, rubber particles, a coloring agent such as a dye or a pigment, an antioxidant, an ultraviolet absorbent, a light diffusion agent, a delustering agent, a light stabilizer, a release agent, a flame retardant, and an antistatic agent. Particularly, to blend rubber particles with methacrylic resins is preferable, since the impact resistance and the flexibility of the resin substrate are improved and cracking hardly occurs.

Examples of the rubber particles to be used include various rubber particles such as acrylic, butadiene, and styrene-butadiene rubber particles and particularly, in terms of weathering resistance, acrylic rubber particles are preferably used. Examples of the acrylic rubber particles to be used include particles having a monolayer structure and comprising an elastic polymer containing mainly an alkyl acrylate such as butyl acrylate and particles having a multilayer structure provided with an outer layer comprising an elastic polymer containing mainly an alkyl acrylate such as butyl acrylate on the circumference of an inner layer comprising a hard polymer containing mainly methyl methacrylate. In addition, generally, a slight amount of a polyfunctional monomer is copolymerized in the above-mentioned elastic polymer.

Further, particles having a multilayer structure provided with an outermost layer comprising a hard polymer containing mainly methyl methacrylate on the circumference of the elastic polymer are also advantageously usable. Examples thereof include particles having a bilayer structure in which an outer layer comprising a hard polymer containing mainly methyl methacrylate is provided on the circumference of an inner layer comprising an elastic polymer containing mainly an alkyl acrylate such as butyl acrylate, and particles having a trilayer structure which comprises a middle layer comprising an elastic polymer containing mainly an alkyl acrylate such as butyl acrylate, an inner layer comprising a hard polymer containing mainly methyl methacrylate and an outer layer comprising a hard polymer containing mainly methyl methacrylate, the outer layer being on the circumference of the middle layer and the middle layer being on the circumference of the inner layer in the particle having a trilayer structure. The rubber particles of such a multilayer structure are disclosed in, for example, JP-B No. 55-27576. Particularly, particles having a trilayer structure are preferable and the composition disclosed in Example 3 of JP-B No. 55-27576 is one of the preferable compositions.

In terms of surface hardness as well as impact resistance and surface smoothness of the resin substrate, particles having an average particle diameter of 0.05 to 0.4 μm are preferably used as the rubber particles. If the average particle diameter of the rubber particles is too small, the surface hardness of the resin substrate may become insufficient or the resin substrate may become brittle. On the other hand, if the average particle diameter of the rubber particles is too large, the surface smoothness of the resin substrate tends to be lost. The rubber particles are generally produced by emulsion polymerization and at this time, the average particle diameter can be controlled to be a desired value by adjusting the amount of an emulsifying agent to be added and the amount of monomers to be fed.

In the case where the rubber particles are blended to the resin constituting the resin substrate, the ratio of both is preferably 50 to 95 parts by weight of the resin and 5 to 50 parts by weight of the rubber particles. If the amount of the rubber particles is too small, the impact resistance and the flexibility of the resin substrate are not sufficiently improved and if it is too large, the surface hardness and the rigidity of the resin substrate become insufficient and therefore it is not preferable.

The thickness of the resin substrate is generally 0.2 to 3 mm and preferably 0.25 to 2.5 mm. If the thickness is too thin, the strength and the rigidity may sometimes be insufficient as a substrate of the liquid crystal display protection plate and also if the thickness is too thick, it is sometimes improper as a substrate of the liquid crystal display protection plate in terms of the design. In addition, the resin substrate may be used in the shape of a plane or the shape having a curved face in accordance with the surface shape of the display face of the liquid crystal display protection plate.

The resin substrate may have a monolayer structure or multilayer structure. In the case where the resin substrate has a multilayer structure, it is preferable that at least one layer is a methacrylic resin layer and examples of the multilayer structure include a multilayer structure of a methacrylic resin layer containing rubber particles and a methacrylic resin layer containing no rubber particle; a multilayer structure of methacrylic resin layers having different glass transition temperatures; a multilayer structure of a methacrylic resin layer and a polycarbonate resin layer; and a multilayer structure of a methacrylic resin layer and a styrene resin layer.

Further, in the case where the resin substrate has a multilayer structure, it is preferable that the surface layer is a methacrylic resin layer in terms of the scratching resistance and, in the case where both surface layers are methacrylic resin layers, the thickness of each surface layer is generally 3 μm or more, preferably 10 μm or more, and more preferably 30 μm or more and it is made possible to obtain sufficient surface hardness by setting the thickness of the methacrylic resin layer, which is the surface layer, as described above.

As a resin substrate having a multilayer structure, particularly a laminate plate in which a methacrylic resin layer is laminated on at least one face of a polycarbonate resin layer is preferably used since the plate has high mechanical strength, is easy to control an in-plane retardation value within a prescribed range, and is excellent in scratching resistance. In this laminate plate, the thickness of the polycarbonate resin layer is preferably 50% or more in the entire thickness and the thickness of the methacrylic resin layer is, similarly described above, generally 3 μm or more, preferably 10 μm or more, and more preferably 30 μm or more and also generally 120 μm or less, preferably 110 μm or less, and more preferably 100 μm or less, when methacrylic resin layers are laminated on the both faces of the polycarbonate resin layer, the thickness of the methacrylic resin layer means the thickness of each methacrylic resin layer. In addition, in the case where methacrylic resin layers are to be laminated on both faces of a polycarbonate resin layer, both methacrylic resin layers may have the same compositions and thicknesses as each other or have compositions and thicknesses different from each other.

The resin substrate may be produced preferably by extrusion molding. The extrusion molding may be carried out specifically by a melt extrusion method such as a T die method and an inflation method. The surface of the obtained resin substrate may be smooth or may have fine irregularity. In order to provide the smoothness or irregularity, a method of producing a plate by, for example, melt-extruding a raw material resin from a T die and bringing at least one face of the obtained plate-like material into contact with a roll or a belt having a mirror-face or an irregular surface is preferable in terms of production of the plate with good surface property. In this case, as the roll, metal rolls with high rigidity, rubber rolls having elasticity, and metal rolls having elasticity are employed while being properly selected or combined. Further, in order to produce a resin substrate having a multilayer structure, a conventionally known multilayer extrusion apparatus having, for example, a plurality of extruders and a mechanism such as a multi-manifold type and a feed-block type for layering the resins extruded from the extruders can be employed.

In the invention, a liquid crystal display protection plate comprises a scratching-resistant resin plate in which a cured coating film is disposed on at least one face of the resin substrate, which is obtained in the above-mentioned method. The in-plane retardation value of this protection plate is generally 85 to 300 nm, preferably 85 to 250 nm, and more preferably 85 to 200 nm. Use of a substrate having an in-plane retardation value in the prescribed range as a liquid crystal display protection plate suppresses deterioration of the visibility of an image in the case where a screen of a liquid crystal display is seen through a polarizing filter such as polarizing sunglasses and efficiently protects the liquid crystal display. If the in-plane retardation value is too small, the screen of the liquid crystal display becomes dark to lower the visibility of an image. Further, if the retardation value is too higher, the screen of the liquid crystal display is colored to lower the visibility of an image. It may be preferable that the in-plane retardation value of the protection plate is not fluctuated significantly in accordance with the position of the protection plate and the fluctuation is preferably ±50 nm, more preferably ±20 nm, and even more preferably ±10 nm to the center value.

In order to constitute the above specified liquid crystal display protection plate having an in-plane retardation value of 85 to 300 nm, in one embodiment of the invention, a substrate having an in-plane retardation value of 90 to 300 nm is used as a resin substrate. It is preferable to employ a method for producing such a resin substrate which involves subjecting a resin easy to control the in-plane retardation value within the prescribed range to extrusion molding as described above and carrying out the molding by bringing both faces of the plate-like material obtained at this time by melt extrusion of the resin into contact with surfaces of two metal rolls with high rigidity while forming resin accumulation called bank. Further, according to this method, the smoothness of the resin substrate or the precision of shape imparting can also be improved.

A curable coating material to be used for forming the cured coating film contains a curable compound which provides scratching resistance as an indispensable component and, based on the necessity, a curing catalyst, conductive particles, a solvent, a leveling agent, and the like.

Examples of the curing compound include acrylate compounds, urethane acrylate compounds, epoxyacrylate compounds, carboxyl group-modified epoxyacrylate compounds, polyester acrylate compounds, copolymerizable acrylate compounds, alicyclic epoxy resins, glycidyl ether epoxy resins, vinyl ether compounds, and oxetane compounds. Among them, in terms of scratching resistance of the cured coating film, radical-polymerizable curable compounds such as polyfunctional acrylate compounds, polyfunctional urethane acrylate compounds, and polyfunctional epoxy acrylate compounds and heat-polymerizable curable compounds such as alkoxysilanes and alkylalkoxysilanes are preferably used. These curable compounds may be preferably compounds curable by irradiating energy beams such as electron beams, radiation beams, ultraviolet rays or compounds curable by heating. These curable compounds may be used alone or a plurality of the compounds may be used in combination with each other.

Particularly preferable curable compounds are compounds having at least three (meth)acryloyloxy groups in a molecule. Herein, the (meth)acryloyloxy groups include acryloyloxy groups and methacryloyloxy groups. In addition, in this specification, “(meth)” in the case of (meth)acrylate and (meth) acrylic acid is also the same meaning.

Examples of the compounds having at least three (meth)acryloyloxy groups in a molecule include poly(meth)acrylate of tri- or more polyhydric alcohols such as trimethylolpropane tri(meth)acrylate, trimethylolethane tri(meth)acrylate, glycerin tri(meth)acrylate, pentaglycerol tri(meth)acrylate, pentaerythritol tri- or tetra-(meth)acrylate, dipentaerythritol tri-, tetra-, penta-, or hexa-(meth)acrylate, and tripentaerythritol tetra-, penta-, hexa-, or hepta-(meth)acrylate; urethane (meth)acrylates obtained by reaction of a compound having at least two isocyanato groups in a molecule and a (meth)acrylate having a hydroxyl group at a ratio of equimolecular or more of the hydroxyl group to the isocyanato group and having three or more of (meth)acryloyloxy groups in a molecule (e.g. a hexafunctional urethane (meth)acrylate obtained by reaction of a diisocyanate and pentaerythritol tri(meth)acrylate); and the tri(meth)acrylate of tris(2-hydroyethyl)isocyanuric acid. Herein, these exemplary monomers may be used as they are or in the form of oligomers such as dimmers or trimers. Further, monomers and oligomers may be used in combination with each other.

The commercialized products of the compound having at least three (meth) acryloyloxy groups in a molecule include, for example, “NK HARD M101” (urethane acrylate), “NK ESTER A-TMM-3L” (pentaerythritol triacrylate), “NK ESTER A-TMMT” (pentaerythritol tetraacrylate), “NK ESTER A-9530” (dipentaerythritol pentaacrylate), and “NK ESTER A-DPH” (dipentaerythritol hexaacrylate) manufactured by Shin-Nakamura Chemical Co., Ltd.; “KAYARAD DPCA” (dipentaerythritol hexaacrylate) manufactured by Nippon Kayaku Co., Ltd.; “Nopcocure 200” series manufactured by San Nopco Limited; and “Unidic” series manufactured by DIC Corporation.

The content of the compound having at least three (meth)acryloyloxy groups in a molecule is used at a ratio of preferably 50 parts by weight or more and more preferably 60 parts by weight or more based on 100 parts by weight of a solid matter of the curable coating material, in terms of surface hardness of the cured coating film.

Other than the compound having at least three (meth)acryloyloxy groups in a molecule, mixed polyesters of saturated or unsaturated dibasic acids and (meth)acrylic acids such as malonic acid/trimethylolethane/(meth)acrylic acid, malonic acid/trimethylolpropane/(meth)acrylic acid, malonic acid/glycerin/(meth)acrylic acid, malonic acid/pentaerythritol/(meth)acrylic acid, succinic acid/trimethylolethane/(meth)acrylic acid, succinic acid/trimethylolpropane/(meth)acrylic acid, succinic acid/glycerin/(meth)acrylic acid, succinic acid/pentaerythritol/(meth)acrylic acid, adipic acid/trimethylolethane/(meth)acrylic acid, adipic acid/trimethylolpropane/(meth)acrylic acid, adipic acid/glycerin/(meth)acrylic acid, adipic acid/pentaerythritol/(meth)acrylic acid, glutaric acid/trimethylolethane/(meth)acrylic acid, glutaric acid/trimethylolpropane/(meth)acrylic acid, glutaric acid/glycerin/(meth)acrylic acid, glutaric acid/pentaerythritol/(meth)acrylic acid, sebacic acid/trimethylolethane/(meth)acrylic acid, sebacic acid/trimethylolpropane/(meth)acrylic acid, sebacic acid/glycerin/(meth)acrylic acid, sebacic acid/pentaerythritol/(meth)acrylic acid, fumaric acid/trimethylolethane/(meth)acrylic acid, fumaric acid/trimethylolpropane/(meth)acrylic acid, fumaric acid/glycerin/(meth)acrylic acid, fumaric acid/pentaerythritol/(meth)acrylic acid, itaconic acid/trimethylolethane/(meth)acrylic acid, itaconic acid/trimethylolpropane/(meth)acrylic acid, itaconic acid/pentaerythritol/(meth)acrylic acid, maleic anhydride/trimethylolethane/(meth)acrylic acid, maleic anhydride/glycerin/(meth)acrylic acid may be used as curable compounds. These mixed polyesters may be used in combination with the compound having at least three (meth)acryloyloxy groups in a molecule.

In the case of curing the curable coating material with ultraviolet rays, it is preferable to use a photopolymerization initiator as a curing catalyst. Examples of the photopolymerization initiator include benzil, benzophenone and its derivatives, thioxanthones, benzyl dimethyl ketals, α-hydroxyalkylphenones, hydroxyketones, aminoalkylphenones, and acyiphosphine oxides and based on the necessity, two or more of them may also be used. The amount of the photopolymerization initiator to be used is generally 0.1 to 5 parts by weight based on 100 parts by weight of the curable compound.

The commercialized products of the photopolymerization initiator include, for example, IRGACURE series and DAROCUR series such as “IRGACURE 651”, “IRGACURE 184”, “IRGACURE 500”, “IRGACURE 1000”, “IRGACURE 2959”, “DAROCUR 1173”, “IRGACURE 907”, “IRGACURE 369”, “IRGACURE 1700”, “IRGACURE 1800”, “IRGACURE 819”, and “IRGACURE 784” manufactured by Ciba Specialty Chemicals Inc. and KAYACURE series such as “KAYACURE ITX”, “KAYACURE DETX-S”, “KAYACURE BP-100”, “KAYACURE EMS”, and “KAYACURE 2-EAQ” manufactured by Nippon Kayaku Co., Ltd.

If the curable coating material contains conductive particles, the cured coating film can exhibit an antistatic property. As the conductive particles, inorganic particles such as antimony-doped tin oxide, phosphorus-doped tin oxide, antimony oxide, zinc antimonate, titanium oxide, and ITO (indium tin oxide) are preferably used.

The particle diameter of the conductive particles is generally 0.5 μm or smaller and in terms of the antistatic property and transparency of the cured coating film, when expressed in average particle diameter, it is preferably 0.001 μm or larger and preferably 0.1 μm or smaller and more preferably 0.05 μm or smaller. As the average particle diameter of the conductive particles is smaller, the haze of the liquid crystal display protection plate can be lowered and the transparency can be heightened.

The amount of the conductive particles to be used is generally 2 to 50 parts by weight and preferably 3 to 20 parts by weight based on 100 parts by weight of the curable compound. As the amount of the conductive particles to be used is higher, the antistatic property of the cured coating film tends to be improved; however if the amount of the conductive particles to be used is too high, the transparency of the cured coating film may be lowered.

The conductive particles may be produced by, for example, a vapor-phase decomposition method, a plasma evaporation method, an alkoxide decomposition method, a coprecipitation method, and a hydrothermal method. Further, the surfaces of the conductive particles may be surface-treated with, for example, a nonionic surfactant, a cationic surfactant, an anionic surfactant, a silicone coupling agent, and an aluminum coupling agent.

The curing coating material may contain a solvent in order to adjust the viscosity and particularly, in the case where conductive particles are contained, the curing coating material may contain a solvent for dispersion of the particles. In the case where the curing coating material containing conductive particles and a solvent is prepared, for example, the conductive particles and the solvent may be mixed to disperse the conductive particles in the solvent and thereafter to mix this dispersion with the curable compound, or the curable compound and the solvent may be mixed to thereafter disperse the conductive particles in the mixed solution.

The solvents are preferably solvents which can dissolve the curable compound and are easy to be evaporated after coating and in the case where conductive particles are used as a coating material component, the solvents are preferably solvents in which the conductive particles can be dispersed. Examples of the solvent include alcohols such as diacetone alcohol, methanol, ethanol, isopropyl alcohol, isobutyl alcohol, 2-methoxyethanol, 2-ethoxyethanol, 2-butoxyethanol, and 1-methoxy-2-propanol, ketones such as acetone, methyl ethyl ketone, methyl isobutyl ketone, and diacetone alcohol, aromatic hydrocarbons such as toluene and xylene, esters such as ethyl acetate and butyl acetate, and water. The amount of the solvent to be used may be properly adjusted in accordance with the properties of the curable compound.

In the case where the curable coating material contains a leveling agent, silicone oil is preferably used and examples of the silicone oil include dimethylsilicone oil, phenylmethylsilicone oil, alkyl-aralkyl-modified silicone oil, fluorosilicone oil, polyether-modified silicone oil, fatty acid ester-modified silicone oil, methyl hydrogen silicone oil, silanol group-containing silicone oil, alkoxy group-containing silicone oil, phenol group-containing silicone oil, methacryl-modified silicone oil, amino-modified silicone oil, carboxylic acid-modified silicone oil, carbinol-modified silicone oil, epoxy-modified silicone oil, mercapto-modified silicone oil, fluorine-modified silicone oil, and polyether-modified silicone oil. These leveling agents may be used alone or two or more kinds of them may also be used by mixing. The amount of the leveling agent to be used is generally 0.01 to 5 parts by weight based on 100 parts by weight of the curable compound.

The commercialized products of the leveling agent include, for example, “SH200-100 CS”, “SH289P”, “SH299P”, “SH309P”, “ST839P”, “ST809P”, “ST979P”, and “ST869P” manufactured by Dow Corning Toray Co., Ltd.

The curable coating material obtained in such a method is applied to at least one face of a resin substrate to form a curable coating material film and then the film is cured to form a cured coating film and accordingly a scratching-resistant resin plate in which the cured coating film is disposed on at least one face of the resin substrate can be obtained.

The application of the curable coating material may be carried out by a coating method such as a bar coating method, a micro-gravure coating method, a roll coating method, a flow coating method, a dip coating method, a spin coating method, a die coating method and a spray coating method. The curing of the curable coating film may be carried out properly by irradiating energy beams or heating in accordance with the kind of the curable coating material.

In the case where the curing is carried out by irradiating energy beams, the energy beams to be employed include, for example, ultraviolet rays, electron beams, and radiation beams and the conditions such as the intensity and the irradiation time may properly be selected in accordance with the kind of the curable coating material. Further, in the case where curing is carried out by heating, the conditions such as the temperature and the time, may properly selected in accordance with the kind of the curable coating material; however the heating temperature is generally preferably 100° C. or lower so as not to cause deformation of the resin substrate. In the case where the curable coating material contains a solvent, the curable coating film may be cured after application of the coating material and then evaporation of the solvent, or evaporation of the solvent may be carried out simultaneously with curing of the curable coating film.

The thickness of the cured coating film is preferably 0.5 to 50 μm and more preferably 1 to 20 μm. As the thickness of the cured coating film is less, cracking tends to hardly generate; however if it is too thin, the scratching resistance tends to become insufficient.

With respect to the scratching-resistant resin plate obtained in this method, in another embodiment of the invention, a film having an in-plane retardation value of 90 to 300 nm is stuck to the resin substrate to constitute the liquid crystal display protection plate of the invention having an in-plane retardation value of 85 to 300 nm. This embodiment is generally employed in the case where the in-plane retardation value of the scratching-resistant resin plate is less than 85 nm and specifically, it may be an embodiment of the scratching-resistant resin plate in which a cured coating film is disposed on one face of the resin substrate and a film having an in-plane retardation value of 90 to 300 nm is stuck to the face of the resin substrate, the face being on the opposite side of the cured coating film side, or an embodiment of the scratching-resistant resin plate in which at least one cured coating film is disposed on each face of the resin substrate and the film having an in-plane retardation value of 90 to 300 nm is stuck to one of the cured coating films.

As the film having an in-plane retardation value of 90 to 300 nm, films obtained by molding a thermoplastic resin easy to control the in-plane retardation value within a prescribed range into a film-like shape, aside from the resin substrate, may be used or commercialized films having an in-plane retardation value within a prescribed range, for example, phase difference films may be used.

The film having an in-plane retardation value of 90 to 300 nm may be stuck to the scratching-resistant resin plate obtained by forming a cured coating film on the resin substrate with a pressure sensitive adhesive or an adhesive interposed therebetween or may be stuck to the resin substrate by heat or with a pressure sensitive adhesive or an adhesive interposed therebetween and then the cured coating film may be formed. The material to be used preferably as this film may be polycarbonate resins and polyester resins such as polyethylene terephthalate. Similarly to the foregoing resin substrate, it may be preferable that the in-plane retardation value of this film is not fluctuated significantly in accordance with the position of the film and the fluctuation is preferably ±50 nm, more preferably ±20 nm, and even more preferably ±10 nm to the center value.

The surface of the scratching-resistant resin plate may be subjected to reflection preventive treatment by a conventionally known method such as a coating method, a sputtering method, and a vacuum evaporation method. Further, it is also possible to provide a reflection preventive effect by sticking a reflection-preventing sheet produced separately to one face or both faces of the scratching-resistant resin plate.

When the scratching-resistant resin plate having an in-plane retardation value of 85 to 300 nm or the film-bearing scratching-resistant resin plate obtained in the above-mentioned method is used as a liquid crystal display protection plate, deterioration of the visibility of an image can be suppressed in the case of seeing a screen of a liquid crystal display through a polarizing filter such as polarizing sunglasses and the liquid crystal display can efficiently be protected. The applications of the liquid crystal display to be protected include, for example, monitors of televisions or computers, display windows of portable type information terminals such as mobile phones, PHS (Personal Handy-phone System), and PDA (Personal Digital Assistant), finder parts of digital cameras and handy type video cameras, and display windows of portable type game machines. The liquid crystal display protection plate of the invention is preferably used particularly for display window protection plates of portable type information terminals of liquid crystal displays and exhibits an advantageous effect as a display window protection plate of, in particular, a mobile phone having a display part including a display window which is folded and covers an operation button part at the time when the mobile phone is not used.

In order to produce a liquid crystal display protection plate from the scratching-resistant resin plate or film-bearing scratching-resistant resin plate, first, processing such as printing and piercing is carried out based on the necessity and cutting treatment into a needed size is carried out. Thereafter, if the protection plate is set in a liquid crystal display, the liquid crystal display can efficiently be protected. At this time, if the liquid crystal display protection plate is a plate comprising a scratching-resistant resin plate in which a cured coating film is disposed only on one face of the resin substrate, it is preferable to set the side where the cured coating film is disposed in the front side (the viewer side) and the side where the cured coating film is not disposed in the rear side (the liquid crystal display side). Further, if the liquid crystal display protection plate is a plate comprising a scratching-resistant resin plate in which at least one cured coating film is disposed on each face of a resin substrate in which a methacrylic resin layer is laminated only on one face of a polycarbonate resin layer, it is preferable to set the methacrylic resin layer side in the front side and the polycarbonate resin side in the rear side.

### EXAMPLES

Hereinafter, Examples of the invention will be shown, however the invention should not be limited to these Examples. In Examples, % and part (s) showing the contents or the amounts to be used are on the basis of weight unless otherwise specified.

### Example 1

### (A) Production of Resin Substrate

A polycarbonate resin (“CALIBRE 301-10” manufactured by Sumitomo Dow Limited) was melted and kneaded by using a uniaxial extruder with 40 mmφ and a methacrylic resin (“SUMIPEX MH” manufactured by Sumitomo Chemical Co., Ltd.) was melted and kneaded by using a uniaxial extruder with 20 mmφ and both were formed into a trilayer structure having the methacrylic resin in both surface layers with a feed block method and extruded through a T-type die and while forming a bank, the resulting product was sandwiched between two rigid polishing rolls comprising a metal and molded and cooled to obtain a multilayer resin substrate with a thickness of 1.0 mm. At this time, the thicknesses of the respective layers were adjusted to methacrylic resin layer/polycarbonate resin layer/methacrylic resin layer=0.05 mm/0.9 mm/0.05 mm. The in-plane retardation value of the resin substrate was measured by an automatic birefringence meter (“KOBRA-CCD/X” manufactured by Oji Scientific Instruments Co., Ltd.) to find that the value was 123 nm.

### (B) Preparation of Curable Coating Material

A curable coating material was prepared by mixing 30 parts of dipentaerythritol hexaacrylate (“NK ESTER A-DPH” manufactured by Shin-Nakamura Chemical Co., Ltd.), 20 parts of 1-methoxy-2-propanol, 50 parts of 2-ethoxyethanol, 2 parts of a photopolymerization initiator (“IRGACURE 184” manufactured by Ciba Specialty Chemicals Inc.), and 0.045 parts of silicone oil (“SH28A” manufactured by Dow Corning Toray Co., Ltd.).

### (C) Manufacture of Scratching-Resistant Resin Plate

The resin substrate obtained in (A) was immersed in the curable coating material obtained in (B) and pulled up at 5 mm/s speed to form coating films of the curable coating material on both faces of the resin substrate. Next, the solvents were evaporated by drying at room temperature for 1 minute and thereafter at 45° C. for 10 minutes in a hot air oven and the coating films were irradiated with 0.5 J/cm² of the ultraviolet rays by using a 120 W high pressure mercury lamp and cured to obtain a scratching-resistant resin plate. The scratching-resistant resin plate was subjected to the following evaluations and the results are shown in Table 1.

### [In-Plane Retardation Value (Re)]

An in-plane retardation value (Re) was measured by using an automatic birefringence meter (“KOBRA-CCD/X” manufactured by Oji Scientific Instruments Co., Ltd.).

### [Thickness of Cured Coating Film (Film Thickness)]

A thickness of cured coating film (film thickness) was measured by using a high speed microscopic film thickness measurement meter (“MS-2000” manufactured by Otsuka Electronics Co., Ltd.).

### [Total Luminous Transmittance (Tt) and Haze (H)]

Total luminous transmittance (Tt) and haze (H) were according to JIS K7105.

### [Scratching Resistance]

The surface of the cured coating film surface of the scratching-resistant resin plate was rubbed with steel wool #0000 10 times at 500 g/cm². At this time, the shape of the steel wool to be brought into contact with the surface of the cured coating film was made to be a square with 2 cm (surface area 4 cm²) and fibers were arranged in parallel to the sides. Further, the rubbing was carried out at the rubbing distance of 10 cm (5 cm for one way) and the speed of 1 second for one rubbing in the fiber direction. After 10 times rubbing, the scratching state of the surface was observed with eyes and evaluated according to the following four grades.

A: no scratch, B: 1 to 2 scratches, C: 3 to 10 scratches, and D: more than 10 scratches.

### [Visibility]

Each scratching-resistant resin plate was arranged on a liquid crystal display while forming an angle of 45° between the transmittance axis of the polarizer of the liquid crystal display and the extrusion direction of the resin substrate of the scratching-resistant resin plate, and a polarizing film was arranged thereon such that the transmission axis of the polarizer of the liquid crystal display and the transmission axis of the polarizer of the polarizing film crossed at right angles each other (in a state where outgoing light from the liquid crystal display was not transmitted and the screen was pitch dark and no image was seen in the case where no scratching-resistant resin plate is existed). At this time, the brightness of the screen and the way how an image was seen were observed by eyes and evaluated according to the following three grades.

A; the screen was bright and no coloration was observed and an image was seen clearly, B: the screen was dark or colored and an image was hard to be seen, and C: the screen was pitch dark or intensely colored and no image was seen.

### Comparative Example 1

### (A2) Production of Resin Substrate

A polycarbonate resin (“CALIBRE 301-10” manufactured by Sumitomo Dow Limited) was melted and kneaded by using a uniaxial extruder with 40 mmφ and a methacrylic resin (“SUMIPEX EX” manufactured by Sumitomo Chemical Co., Ltd.) was melted and kneaded by using a uniaxial extruder with 20 mmφ and both were formed into a trilayer structure having the methacrylic resin in both surface layers with a feed block method and extruded through a T-type die and without forming a bank, the resulting product was sandwiched between one rigid polishing roll comprising a metal and one elastic roll comprising a metal obtained by winding metal sleeve around a rubber roll and molded and cooled to obtain a multilayer resin substrate with a thickness of 1.0 mm. At this time, the thicknesses of the respective layers were adjusted to methacrylic resin layer/polycarbonate resin layer/methacrylic resin layer=0.05 mm/0.9 mm/0.05 mm. The in-plane retardation value of the resin substrate was measured by an automatic birefringence meter (“KOBRA-CCD/X” manufactured by Oji Scientific Instruments Co., Ltd.) to find that the value was 85 nm.

Using the resin substrate obtained in (A2), the same operation as that of Example 1 (C) was carried out and the obtained scratching-resistant resin plate was evaluated in the same method as in Example 1 and the results were shown in Table 1.

### Example 2

### (D) Production of Film

A polycarbonate resin (“CALIBRE 301-10” manufactured by Sumitomo Dow Limited) was melted and kneaded by using a uniaxial extruder with 90 mmφ and extruded through a T-type die and while forming a bank, the resulting product was sandwiched between two rigid polishing rolls comprising a metal and molded and cooled to obtain a film with a thickness of 0.2 mm. The in-plane retardation value of the film was measured by an automatic birefringence meter (“KOBRA-CCD/X” manufactured by Oji Scientific Instruments Co., Ltd.) to find that the value was 104 nm.

The film obtained in (D) was stuck to one face of the scratching-resistant resin plate obtained in Comparative Example 1, which was the face with which the rigid rolls comprising a metal were brought into contact when the resin substrate of the scratching-resistant resin plate was produced, with a pressure-sensitive adhesive interposed therebetween and the obtained scratching-resistant resin plate bearing the film was evaluated in the same method as in Example 1 and the results were shown in Table 1. In addition, the evaluation of the scratching resistance was carried out for the surface of the cured coating film where the film was not stuck. The evaluation of the visibility was carried out while the side where the film was stuck was set toward the liquid crystal display side.

### Comparative Example 2

### (A3) Production of Resin Substrate

A methacrylic resin (“SUMIPEX EX” manufactured by Sumitomo Chemical Co., Ltd.) was melted and kneaded by using a uniaxial extruder with 40 mmφ and extruded through a T-type die and without forming a bank, the resulting product was sandwiched between one rigid polishing roll comprising a metal and one elastic roll comprising a metal obtained by winding metal sleeve around a rubber roll and molded and cooled to obtain a monolayer resin substrate with a thickness of 1.0 mm. The in-plane retardation value of the resin substrate was measured by an automatic birefringence meter (“KOBRA-CCD/X” manufactured by Oji Scientific Instruments Co., Ltd.) to find that the value was 13 nm.

Using the resin substrate obtained in (A3), the same operation as that of Example 1 (C) was carried out and the obtained scratching-resistant resin plate was evaluated in the same method as in Example 1 and the results were shown in Table 1.

### Comparative Example 3

### (A4) Production of Resin Substrate

A methacrylic resin (“SUMIPEX MH” manufactured by Sumitomo Chemical Co Ltd.) was melted and kneaded by using a uniaxial extruder with 40 mmφ and extruded through a T-type die and while forming a bank, the resulting product was sandwiched between two rigid polishing rolls comprising a metal and molded and cooled to obtain a monolayer resin substrate with a thickness of 1.0 mm. The in-plane retardation value of the resin substrate was measured by an automatic birefringence meter (“KOBRA-CCD/X” manufactured by Oji Scientific Instruments Co., Ltd.) to find that the value was 54 nm.

Using the resin substrate obtained in (A4), the same operation as that of Example 1 (C) was carried out and the obtained scratching-resistant resin plate was evaluated in the same method as in Example 1 and the results were shown in Table 1.

### Example 3

### (A5) Production of Resin Substrate

A polycarbonate resin (“CALIBRE 301-10” manufactured by Sumitomo Dow Limited) was melted and kneaded by using a uniaxial extruder with 40 mmφ and a methacrylic resin (“SUMIPEX MB” manufactured by Sumitomo Chemical Co., Ltd.) was melted and kneaded by using a uniaxial extruder with 20 mmφ and both were formed into a bilayer structure with a feed block method and extruded through a T-type die and while forming a bank, the resulting product was sandwiched between one rigid polishing roll comprising a metal and one elastic roll comprising a metal obtained by winding metal sleeve around a rubber roll such that the polycarbonate resin layer was brought into contact with the elastic roll comprising a metal and molded and cooled to obtain a multilayer resin substrate with a thickness of 0.5 mm. At this time, the thicknesses of the respective layers were adjusted to methacrylic resin layer/polycarbonate resin layer=0.07 mm/0.43 mm. The in-plane retardation value of the resin substrate was measured by an automatic birefringence meter (“KOBRA-CCD/X” manufactured by Oji Scientific Instruments Co., Ltd.) to find that the value was 97 nm.

### (B2) Preparation of Curable Coating Material

A curable coating material was prepared by mixing 28 parts of dipentaerythritol hexaacrylate (“NK ESTER A-DPH” manufactured by Shin-Nakamura Chemical Co., Ltd.), 1 part of a photopolymerization initiator (“IRGACURE 184” manufactured by Ciba Specialty Chemicals Inc.), 8 parts of antimony pentoxide fine particle sol (“ELCOM-7514”; solid matter concentration 20%, manufactured by Shokubai Kasei Kogyo Ltd.), 32 parts of 1-methoxy-2-propanol, 32 parts of isobutyl alcohol, and 0.045 parts of silicone oil (“SH289P”, manufactured by Dow Corning Toray Co., Ltd.)

### (B3) Preparation of Curable Coating Material

The obtained curable coating material was prepared by mixing 13.5 parts of dipentaerythritol hexaacrylate (“NK ESTER A-DPH” manufactured by Shin-Nakamura Chemical Co., Ltd.), 1 part of a photopolymerization initiator (“IRGACURE 184” manufactured by Ciba Specialty Chemicals Inc.), 16.5 parts of phosphorus-doped tin oxide (average particle diameter 0.1 μm), 69 parts of 1-methoxy-2-propanol, and 0.02 parts of silicone oil (“SH289P”, manufactured by Dow Corning Toray Co., Ltd.).

### (C2) Manufacture of Scratching-Resistant Resin Plate

A coating film of the curable coating material obtained in (B2) was formed on the methacrylic resin layer of the resin substrate obtained in (A5) by using a No. 20 bar coater. Next, after the solvents were evaporated by drying at room temperature for 1 minute and thereafter at 45° C. for 3 minutes in a hot air oven, the coating film was irradiated with 0.5 J/cm² of the ultraviolet rays by using a 120 W high pressure mercury lamp and cured. Next, a coating film of the curable coating material obtained in (B3) was formed on the polycarbonate resin layer of the resin substrate by using a No. 20 bar caster. Further, after the solvents were evaporated by drying at room temperature for 1 minute and thereafter at 45° C. for 3 minutes in a hot air oven, the coating film was irradiated with 0.5 J/cm² of the ultraviolet rays by using a 120 W high pressure mercury lamp and cured, and thus a scratching-resistant resin plate in which scratching-resistant coating films were disposed on both sides of the resin substrate was obtained. The obtained scratching-resistant resin plate was evaluated in the same method as in Example 1 and the results were shown in Table 1. The measurement of the film thickness and evaluation of the scratching resistance were carried out for the cured coating film formed on the methacrylic resin layer.

### Comparative Example 4

### (A6) Production of Resin Substrate

A polycarbonate resin (“CALIBRE 301-10” manufactured by Sumitomo Dow Limited) was melted and kneaded by using a uniaxial extruder with 40 mmφ and a methacrylic resin (“SUMIPEX MH” manufactured by Sumitomo Chemical Co., Ltd.) was melted and kneaded by using a uniaxial extruder with 20 mmφ and both were formed into a bilayer structure with a feed block method and extruded through a T-type die and while forming a bank, the resulting product was sandwiched between two rigid polishing rolls comprising a metal and molded and cooled to obtain a multilayer resin substrate with a thickness of 0.8 mm. At this time, the thicknesses of the respective layers were adjusted to methacrylic resin layer/polycarbonate resin layer=0.07 mm/0.73 mm. The in-plane retardation value of the resin substrate was measured by an automatic birefringence meter (“KOBRA-CCD/X” manufactured by Oji Scientific Instruments Co., Ltd.) to find that the value was 318 nm.

Using the resin substrate obtained in (A6), the same operation as that of Example 3 (C2) was carried out and the obtained scratching-resistant resin plate was evaluated in the same method as in Example 1 and the results were shown in Table 1. The measurement of the film thickness and evaluation of the scratching resistance were carried out for the cured coating film formed on the methacrylic resin layer.

### Example 4

### Acrylic Rubber Particles

Particles used here were spherical rubber particles having a trilayer structure including a hard polymer obtained by emulsion polymerization of monomers comprising 93.8% of methyl methacrylate, 6% of methyl acrylate, and 0.2% of allyl methacrylate as an innermost layer, an elastic polymer obtained by emulsion polymerization of monomers comprising 81% of butyl acrylate, 17% of styrene, and 2% of allyl methacrylate as an intermediate layer, and a hard polymer obtained by emulsion polymerization of monomers comprising 94% of methyl methacrylate and 6% of methyl acrylate as an outermost layer at a weight ratio of the innermost layer/intermediate layer/outermost layer of 35/45/20, an average particle diameter of the elastic polymer of the intermediate layer being 220 nm.

### (E) Preparation of Impact-Resistant Methacrylic Resin Composition

A methacrylic resin (“SUMIPEX MH” manufactured by Sumitomo Chemical Co., Ltd.) and the above-mentioned acrylic rubber particles were mixed by a super mixer such that the ratio of both was adjusted to 94 parts by weight of the methacrylic resin and 6 parts by weight of the acrylic rubber particles and melted and kneaded by a biaxial extruder to obtain an impact-resistant methacrylic resin composition in the form of pellets.

### (A7) Production of Resin Substrate

A polycarbonate resin (“CALIBRE 301-10” manufactured by Sumitomo Dow Limited) was melted and kneaded by using a uniaxial extruder with 40 mmφ and the impact-resistant methacrylic resin composition obtained in (E) was melted and kneaded by using a uniaxial extruder with 20 mmφ and both were formed into a trilayer structure in which the methacrylic resin comprised both surface layers with a feed block method, and extruded through a T-type die and while forming a bank, the resulting product was sandwiched between two rigid polishing rolls comprising a metal and molded and cooled to obtain a multilayer resin substrate with a thickness of 0.5 mm. At this time, the thicknesses of the respective layers were adjusted to impact-resistant methacrylic resin layer/polycarbonate resin layer/impact-resistant methacrylic resin layer=0.07 mm/0.36 mm/0.07 mm. The in-plane retardation value of the resin substrate was measured by an automatic birefringence meter (“KOBRA-CCD/X” manufactured by Oji Scientific Instruments Co., Ltd.) to find that the value was 130 nm.

### (C3) Manufacture of Scratching-Resistant Resin Plate

A coating film of the curable coating material obtained in (B2) was formed on one face of the resin substrate obtained in (A7) by using a No. 20 bar coater. Next, after the solvents were evaporated by drying at room temperature for 1 minute and thereafter at 45° C. for 3 minutes in a hot air oven, the coating film was irradiated with 0.5 J/cm² of the ultraviolet rays by using a 120 W high pressure mercury lamp and cured. Next, a coating film of the curable coating material obtained in (B2) was formed on the other face of the resin substrate by using a No. 20 bar coater. Further, after the solvents were evaporated by drying at room temperature for 1 minute and thereafter at 45° C. for 3 minutes in a hot air oven, the coating film was irradiated with 0.5 J/cm² of the ultraviolet rays by using a 120 W high pressure mercury lamp and cured, and thus a scratching-resistant resin plate in which scratching-resistant coating films were disposed on both sides of the resin substrate was obtained. The obtained scratching-resistant resin plate was evaluated in the same method as in Example 1 and the results were shown in Table 1.

### Example 5

### (A8) Production of Resin Substrate

A polycarbonate resin (“CALIBRE 301-10” manufactured by Sumitomo Dow Limited) was melted and kneaded by using a uniaxial extruder with 40 mmφ and the impact-resistant methacrylic resin composition obtained in (E) was melted and kneaded by using a uniaxial extruder with 20 mmφ and both were formed into a trilayer structure in which the methacrylic resin comprised both surface layers with a feed block method, and extruded through a T-type die and while forming a bank, the resulting product was sandwiched between two rigid polishing rolls comprising a metal and molded and cooled to obtain a multilayer resin substrate with a thickness of 0.8 mm. At this time, the thicknesses of the respective layers were adjusted to impact-resistant methacrylic resin layer/polycarbonate resin layer/impact-resistant methacrylic resin layer 0.07 mm/0.66 mm/0.07 mm. The in-plane retardation value of the resin substrate was measured by an automatic birefringence meter (“KOBRA-CCD/X” manufactured by Oji Scientific Instruments Co., Ltd.) to find that the value was 90 nm.

Using the resin substrate obtained in (A8), the same operation as that of Example 4 (C3) was carried out and the obtained scratching-resistant resin plate was evaluated in the same method as in Example 1 and the results were shown in Table 1.

### Comparative Example 5

### (A9) Production of Resin Substrate

A polycarbonate resin (“CALIBRE 301-10” manufactured by Sumitomo Dow Limited) was melted and kneaded by using a uniaxial extruder with 40 mmφ and the impact-resistant methacrylic resin composition obtained in (E) was melted and kneaded by using a uniaxial extruder with 20 mmφ and both were formed into a trilayer structure in which the methacrylic resin comprised in both surface layers with a feed block method, and extruded through a T-type die and while forming a bank, the resulting product was sandwiched between one rigid polishing roll comprising a metal and one elastic roll comprising a metal obtained by winding metal sleeve around a rubber roll and molded and cooled to obtain a multilayer resin substrate with a thickness of 0.8 mm. At this time, the thicknesses of the respective layers were adjusted to impact-resistant methacrylic resin layer/polycarbonate resin layer/impact-resistant methacrylic resin layer=0.07 mm/0.66 mm/0.07 mm. The in-plane retardation value of the resin substrate was measured by an automatic birefringence meter (“KOBRA-CCD/X” manufactured by Oji Scientific Instruments Co., Ltd.) to find that the value was 41 nm.

Using the resin substrate obtained in (A9), the same operation as that of Example 4 (C3) was carried out and the obtained scratching-resistant resin plate was evaluated in the same method as in Example 1 and the results were shown in Table 1.

TABLE 1

| | | Film | | | | |
|---|---|---|---|---|---|---|
| | Re | thickness | Tt | H | Scratching | |
| Example | (nm) | (μm) | (%) | (%) | resistance | Visibility |
| Example 1 | 120 | 3.3 | 91.5 | 0.3 | A | A |
| Example 2 | 180 | 3.2 | 90.3 | 0.5 | A | A |
| Example 3 | 95 | 3.3 | 89.2 | 0.4 | A | A |
| Example 4 | 128 | 3.2 | 91.2 | 0.2 | A | A |
| Example 5 | 88 | 3.3 | 91.2 | 0.2 | A | A |
| Comparative | 83 | 3.3 | 91.5 | 0.3 | A | B |
| Example 1 | | | | | | |
| Comparative | 12 | 3.0 | 92.0 | 0.2 | A | C |
| Example 2 | | | | | | |
| Comparative | 53 | 3.1 | 92.0 | 0.1 | A | B |
| Example 3 | | | | | | |
| Comparative | 314 | 3.2 | 89.2 | 0.4 | A | B |
| Example 4 | | | | | | |
| Comparative | 38 | 3.3 | 91.3 | 0.2 | A | C |
| Example 5 | | | | | | |

1. A liquid crystal display protection plate,
comprising a scratching-resistant resin plate in which a cured coating film is disposed on at least one face of a resin substrate and
having an in-plane retardation value of 85 to 300 nm.

2. The liquid crystal display protection plate according to claim 1, wherein the resin substrate has an in-plane retardation value of 90 to 300 nm.

3. The liquid crystal display protection plate according to claim 1, wherein the scratching-resistant resin plate is a plate in which a cured coating film is disposed on one face of a resin substrate and a film having an in-plane retardation value of 90 to 300 nm is stuck to the face of the resin substrate, the face being on the opposite side of the cured coating film side.

4. The liquid crystal display protection plate according to claim 1, wherein the scratching-resistant resin plate is a plate in which at least one cured coating film is disposed on each face of a resin substrate and a film having an in-plane retardation value of 90 to 300 nm is stuck to one of the cured coating films.

5. The liquid crystal display protection plate according to claim 1, wherein the thickness of the resin substrate is 0.2 to 3 mm.

6. The liquid crystal display protection plate according to claim 1, wherein the resin substrate is a laminate plate in which a methacrylic resin layer is laminated on at least one face of a polycarbonate resin layer.

7. The liquid crystal display protection plate according to claim 6, wherein the thickness of the polycarbonate resin layer is 50% or more of the thickness of the resin substrate and the thickness of the methacrylic resin layer is 3 μm or more.

8. The liquid crystal display protection plate according to claim 1, wherein the cured coating film is a coating film formed by using a curable coating material containing a compound having at least three (meth)acryloyloxy groups in a molecule.

9. The liquid crystal display protection plate according to claim 1, wherein the cured coating film is a coating film formed by using a curable coating material containing conductive particles.

10. The liquid crystal display protection plate according to claim 1, which is used as a display window protection plate of a portable information terminal having a liquid crystal display as a display window.
